(19) United States
(12) Patent Application Publication
(10) Pub. No.: US 2006/0050773 A1
(43) Pub. Date: Mar. 9, 2006

(54) Receiving apparatus and method for receiving and processing spread spectrum radio signals

(75) Inventor: Motomitsu Yano, Kanagawa-ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/090,871

(22) Filed: Mar. 24, 2005

(30) Foreign Application Priority Data
Sep. 9, 2004 (JP) 2004-262881

(51) Int. Cl. H04B 1/707; H04B 1/69

(52) U.S. Cl. 375/148; 375/147

(57) ABSTRACT

There is provided a receiving apparatus receiving and processing spread spectrum radio signals comprising a plurality of antenna branches, a selective combiner circuit, an evaluation circuit and a control circuit. Each antenna branch is configured to be switched between active and inactive. The evaluation circuit evaluates signals demodulated by each antenna branch and combined by the selective combiner. The control circuit switches off an antenna branch of lower quality of received signals in a case where a figure-of-merit of the selective-combined signal is satisfactory so that power consumption may be reduced.

### CROSS REFERENCE TO RELATED APPLICATIONS

This application is based upon and claims the benefit of priority from the prior Japanese Patent Application No. 2004-262881 filed on Sep. 9, 2004; the entire contents of which are incorporated herein by reference.

### FIELD OF THE INVENTION

The present invention relates to a receiving apparatus and a method for receiving and processing spread spectrum radio signals.

### DESCRIPTION OF THE BACKGROUND

Spread spectrum signals are widely used in radio communications or broadcasting, particularly for mobile users, as they have advantages in terms of interference immunity, keeping privacy, being applicable to multiplexing or multiple access, and so forth. Receivers of spread spectrum signals often use some kind of diversity technology to cope with multipath fading.

Known is a rake receiver receiving spread spectrum signals using antenna diversity and path diversity together. This rake receiver comprises two or more antenna branches each having an antenna and a rake combiner. Spread spectrum signals are received by two or more antennas for antenna diversity, and each received signal is despread and raked up by each rake combiner for path diversity.

This conventional rake receiver is disclosed, e. g., in the following reference:

Fujii, T. and Suzuki, T., “RAKE Received Characteristics Considering Antenna Diversity and Path Diversity for Wide Band DS-CDMA System”, IEICE TRANS., Vol. J82-B, No. 10, pp. 1869-1887 (in Japanese), The Institute of Electronics, Information and Communication Engineers, October 1999.

The above reference shows a configuration and receiving characteristics of a rake receiver using antenna diversity and path diversity together with several ways of path selection.

A rake receiver of this kind has two or more antenna branches, each having an antenna, a radio circuit, a path selector circuit and a rake combiner. In general all the antenna branches are being active or switched on. It may not be necessary, though, if the receiving quality of the rake receiver remains satisfactory with a reduced number of antenna branches being active.

Known is a conventional receiver adopting antenna diversity, having two or more antenna branches and switching off a demodulator belonging to each antenna branch that is rarely used. This conventional receiver is disclosed in Japanese Patent Publication of Unexamined Applications (Kokai) H10-22886, the English version of which is available on a website named “Industrial Property Digital Library” linked from the Japan Patent Office website.

This conventional receiver compares electric field strengths received by each antenna branch for a while, selects the dominant one and switches off the demodulator of each unselected antenna branch.

Known is a conventional adaptive array system configured to reduce the number of operating antenna arrays as long as its receiving quality remains satisfactory. This conventional adaptive array system is disclosed in Japanese Patent Publication of Unexamined Applications (Kokai) 2002-77010, the English version of which is available on a website named “Industrial Property Digital Library” linked from the Japan Patent Office website.

In this conventional adaptive array system signals received by each antenna array are weighed and combined to form adaptive antenna beams, and the number of operating antenna arrays may be reduced or rake combining at a later stage may be bypassed as long as the receiving quality remains satisfactory.

Those conventional techniques, however, have disadvantages to be applied for mobile receivers of spread spectrum signals. Comparing electric field strengths of the above conventional receiver cannot be applied for receiving noise-like spread spectrum signals. Adaptive arrays may be used for base stations but may not be pertinent for mobile receivers coping with ever-changing multipath fading due to processing delays.

### SUMMARY OF THE INVENTION

To solve the technical problems described above, an advantage of the present invention is to provide a receiving apparatus of spread spectrum signals for mobile users, being configured for antenna diversity and capable of saving power consumption.

According to one aspect of the present invention to achieve the above advantage, there is provided a receiving apparatus receiving and processing spread spectrum radio signals comprising a plurality of antenna branches, a selective combiner circuit, an evaluation circuit and a control circuit. Each antenna branch is configured to be switched between active and inactive and has a radio circuit connectable to an antenna, a path selector circuit and a rake combiner circuit including a plurality of rake fingers.

The radio circuit receives a spread spectrum signal via the antenna after the spread spectrum signal follows a plurality of paths in a case where multipath occurs. The path selector circuit includes a matched filter to detect each path by detecting a phase of synchronization and a signal-to-interference ratio (SIR) thereof out of the received spread spectrum signal, selects the detected paths as many as the rake fingers at most in decreasing order of the SIRs thereof and assigns each selected path to each rake finger. The rake combiner circuit despreads and demodulates the received spread spectrum signal on each rake finger and rakes up the demodulated signal of every rake finger according to each assigned path.

The selective combiner circuit combines the raked-up signal of each antenna branch as selective combining. The evaluation circuit evaluates a figure of merit of the selective-combined signal by a criterion. The control circuit determines a branch SIR as one of the maximum value and the mean value of the SIR of each selected path for each antenna branch, and manages to switch off one of the antenna branches being active and of the minimum branch SIR in a case where at least two of the antenna branches are being active and the criterion is met.

### BRIEF DESCRIPTION OF THE DRAWINGS

FIG. 1 is a block diagram of a main part of a receiving apparatus in a first embodiment of the present invention.

FIG. 2 is a flow chart of a procedure of switching off or on each antenna branch in the first embodiment.

FIG. 3 illustrates an example of a series of pulses of spreading code correlation in the first embodiment.

FIG. 4 is a block diagram of a main part of a receiving apparatus in a second embodiment of the present invention.

FIG. 5 is a block diagram of a main part of a receiving apparatus in a third embodiment of the present invention.

FIG. 6 is an example of a constellation diagram where received symbols are plotted in the third embodiment.

FIG. 7 is a flow chart of a procedure of switching off or on each antenna branch in the third embodiment.

FIG. 8 is a block diagram of a main part of a receiving apparatus in a fourth embodiment of the present invention.

FIG. 9 is a flow chart of a procedure of switching off or on each antenna branch in the fourth embodiment.

FIG. 10 is a block diagram of a main part of a receiving apparatus in a fifth embodiment of the present invention.

FIG. 11 is a flow chart of a procedure of switching off or on each antenna branch in the fifth embodiment.

FIG. 12 is a block diagram of a main part of another receiving apparatus in the fifth embodiment of the present invention.

FIG. 13 is a block diagram of a main part of a receiving apparatus in a sixth embodiment of the present invention.

FIG. 14 is a flow chart of a procedure of switching off or on each antenna branch in the sixth embodiment.

### DETAILED DESCRIPTION OF THE INVENTION

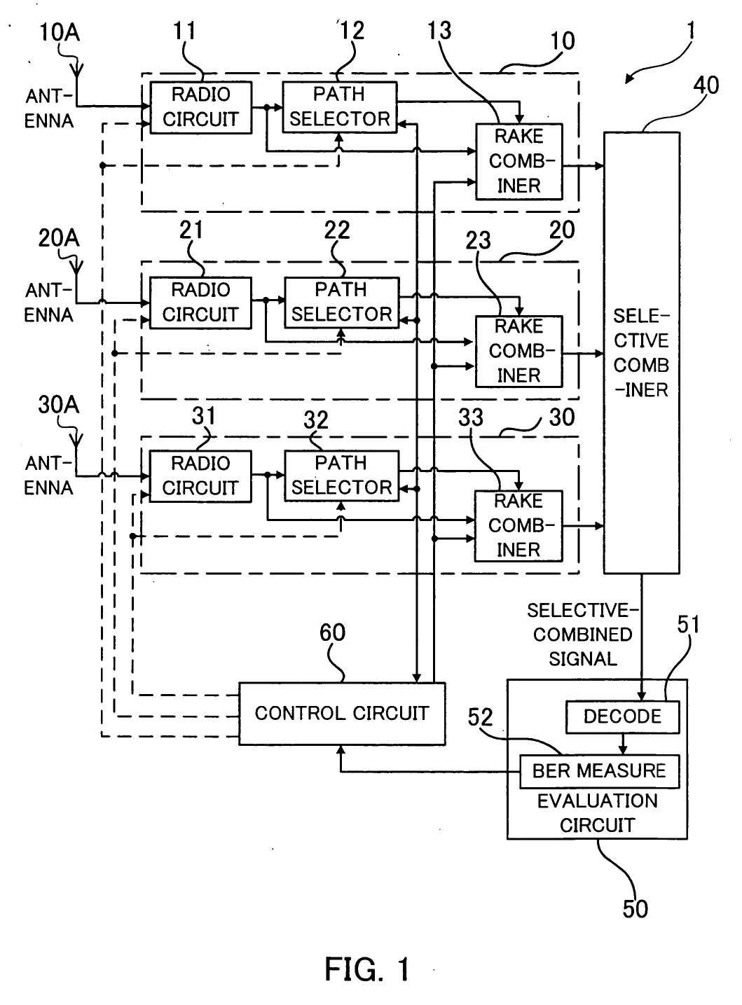

A first embodiment of the present invention will be described with reference to FIG. 1 through FIG. 3. FIG. 1 is a block diagram of a main part of a receiving apparatus 1 in the first embodiment. The receiving apparatus 1 has three antenna branches 10, 20 and 30. Each antenna branch 10, 20 or 30 is configured to be switched between active and inactive.

The antenna branch 10 has a radio circuit 11, a path selector circuit 12 and a rake combiner circuit 13 in a cascade connection of this order. The radio circuit 11 is connectable to an antenna 10A and receives spread spectrum signals via the antenna 10A. In a multipath environment, the radio circuit 11 receives a spread spectrum signal that has followed two or more paths and reached the antenna 10A. That is, the spread spectrum signal is received after following two or more paths. The path selector circuit 12 includes a matched filter (not shown) to detect the paths and the rake combiner circuit 13 includes a plurality of rake fingers (not shown) to despread the received spread spectrum signal for each path.

The path selector circuit 12 detects the paths by detecting its phase of synchronization and its SIR using the matched filter, then selects the detected paths as many as the rake fingers in decreasing order of their SIRs, and assigns each selected path to each rake finger. The rake combiner circuit 13 despreads and demodulates the received spread spectrum signal on each rake finger, and rakes up the demodulated signal of every rake finger according to each assigned path.

The antenna branch 20 has a radio circuit 21, a path selector circuit 22 and a rake combiner circuit 23 and its configuration is the same as that of the antenna branch 10. The antenna branch 30 has a radio circuit 31, a path selector circuit 32 and a rake combiner circuit 33 and its configuration is the same as that of the antenna branch 10. The radio circuit 21 is connectable to an antenna 20A. The radio circuit 31 is connectable to an antenna 30A. The antennas 10A, 20A or 30A may or may not be included in the receiving apparatus 1. The location of each antenna 10A, 20A or 30A is different one another so that an antenna diversity effect is obtained.

The receiving apparatus 1 has a selective combiner circuit 40 that combines the raked-up signal of each active antenna branch 10, 20 or 30 one another as selective combining. The selective-combined signal is evaluated by an evaluation circuit 50 having a decoding circuit 51 and a BER measuring circuit 52 by a criterion, e. g., a bit-error-rate (BER) of that signal after being decoded.

A control circuit 60 manages to switch each antenna branch 10, 20 or 30 between active and inactive, i.e., to switch on or off each antenna branch 10, 20 or 30.

When the control circuit 60 switches on or off the antenna branch 10, it turns on or off supplying power at least to the radio circuit 11 and the path selector circuit 12. In FIG. 1 a dashed line with an arrow from the control circuit 60 to the radio circuit 11 and the path selector circuit 12 expresses that control. The control circuit 60 switches on or off the antenna branch 20 or 30 in the same manner.

A spread spectrum signal that reaches the antennas 10A, 20A and 30A in a multipath environment will be received and processed by the receiving apparatus 1 as follows. Assume that all the antenna branches 10, 20 and 30 are active in the beginning. A flow of receiving and processing the spread spectrum signal on the antenna branch 10 will be mainly described, and an explanation of those on the antenna branches 20 and 30 is omitted.

The spread spectrum signal reaches the antenna 10A at two or more different phases of a spreading code thereof as it has followed two or more paths. The radio circuit 11 performs quadrature detection and analog-to-digital conversion on the spread spectrum signal, and may perform a gain control or roll-off filtering as necessary. The received spread spectrum signal is thus converted into a digital quadrature (I/Q) signal.

The digital I/Q signal is applied to the matched filter of the path selector circuit 12 so that a correlation with a fixed spreading code provided by the control circuit 60 is examined for one cycle. The matched filter produces a pulse when the phases of the digital I/Q signal and the fixed spreading code are synchronized and they correlate to each other. And a series of such pulses is produced as the digital I/Q signal includes two or more different phases of the spreading code.

The path selector circuit 12 then recognizes a power level and a phase of synchronization of each pulse attributable to each path. For one of the paths the pulse of any other path is interference, and a ratio of its power to a sum of the power of all the other paths is an SIR of that path. The path selector circuit 12 thus detects each path by detecting its phase of synchronization and its SIR.

The path selector circuit 12 selects a plurality of detected paths in decreasing order of their SIRs. The rake combiner circuit 13 has rake fingers as many as the selected paths and each rake finger has a despreading and demodulating circuit. The path selector circuit 12 assigns each path to each rake finger. That is, the path selector circuit 12 gives the despreading and demodulating circuit of each rake finger a pertinent phase of synchronization of each path. And the path selector circuit 12 gives the despread and demodulated signal of each rake finger a pertinent complex weight according to the phase of synchronization and the SIR of the assigned path to be raked up for a path diversity effect. The raked-up signal is a series of received symbols as an output of the antenna branch 10 obtained at the end thereof.

The antenna branch 20 receives and processes a spread spectrum signal that reaches the antenna 20A like the antenna branch 10, and the antenna branch 30 receives and processes a spread spectrum signal that reaches the antenna 30A like the antenna branch 10, respectively. Outputs of the three antenna branches 10, 20 and 30 are combined by the selective combiner circuit 40 as selective combining for an antenna diversity effect.

The selective-combined signal is applied to the evaluation circuit 50, where a figure of merit of that signal to be evaluated is a BER after being decoded. The selective-combined signal is decoded by the decoding circuit 51, and is applied to the BER measuring circuit 52 after being decoded where the BER of the applied signal is measured and evaluated by a criterion. A value of the BER which is no higher than the criterion meets the criterion.

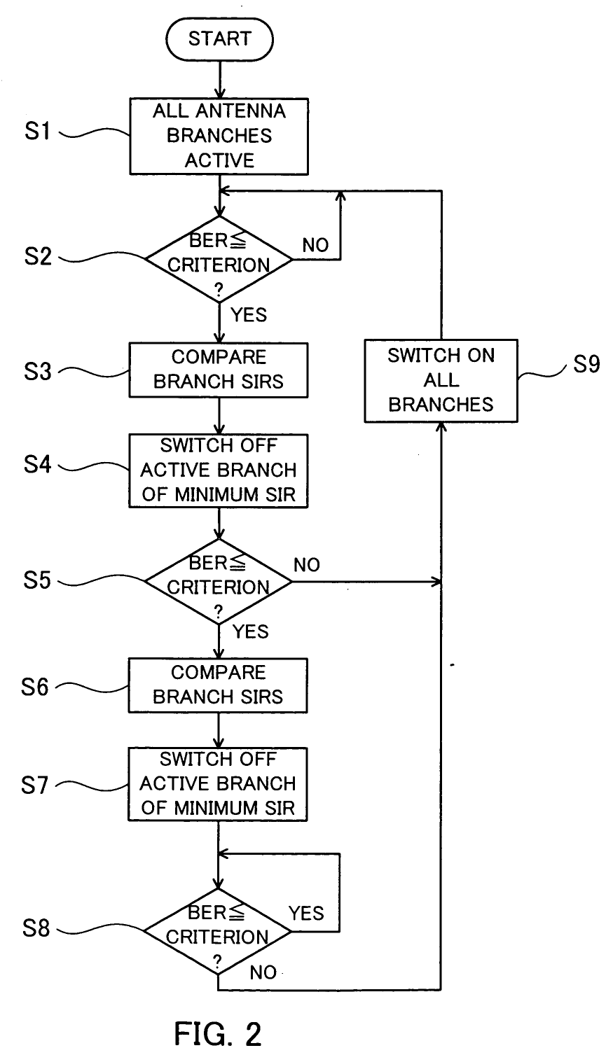

The control circuit 60 obtains a result of the evaluation from the evaluation circuit 50 and manages to switch on or off each antenna branch 10, 20 or 30 based on that result as illustrated in a flow chart of FIG. 2. At first (“START”) all the antenna branches 10, 20 and 30 are being active (step “S1”). The evaluation circuit 50 evaluates the BER of the selective-combined and decoded signal by a criterion of the BER and informs the control circuit 60 of a result of evaluation.

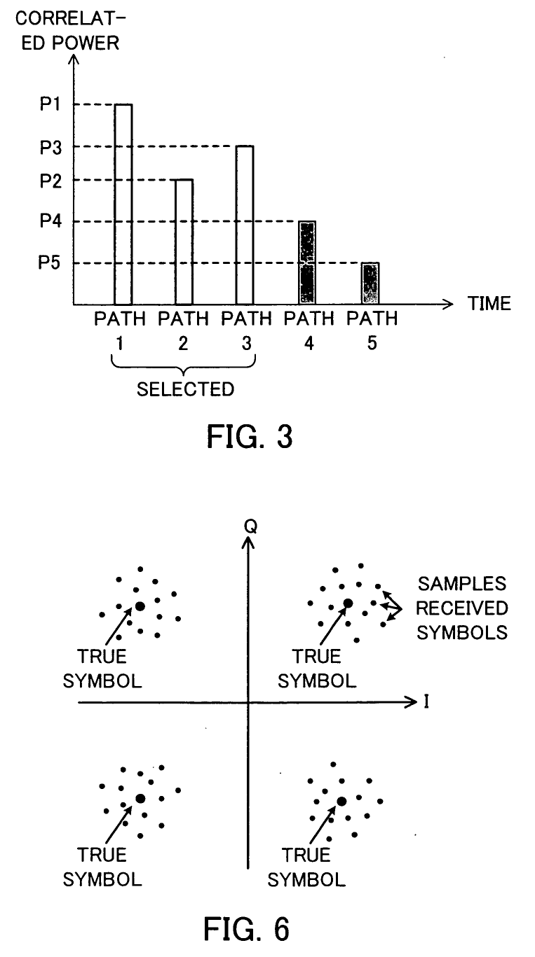

In a case where the BER is no higher than the criterion (“YES” of step “S2”), the control circuit 60 compares the three antenna branches 10, 20 and 30 one another focusing on their SIR characteristics (step “S3”). Comparing the SIR characteristics among the antenna branches 10, 20 and 30 on the step “S3” will be described with reference to FIG. 3 illustrating a series of pulses of the spreading code correlation on the matched filter of the path selector circuit 12, 22 or 32. The horizontal axis is time, and the vertical axis is the power level of each pulse.

Here are assumed five paths indicated as “PATH1” through “PATH 5” in increasing order of their path lengths, and the power level of each path is indicated as “P1” through “P5” respectively shown on the vertical axis. The SIR of “PATH1” is calculated as P1/(P2+P3+P4+P5) as earlier explained and it is indicated as SIR1. The SIR of each of the other paths is similarly calculated and indicated as SIR2 through SIR5. Assume that the number of the rake fingers included in the rake combining circuit 13 is three. Then three of the paths “PATH1”, “PATH2” and “PATH3” are selected in decreasing order of the power of each path or the SIR thereof.

The maximum value of the SIRs of the three selected paths is SIR1, and the mean value of them is (SIR1+SIR2+SIR3)/3. The maximum or the mean value of the SIRs of the selected paths on the antenna branch 10 is defined as a branch SIR of the antenna branch 10. Branch SIRs of the antenna branches 20 and 30 are defined in the same manner.

The control circuit 60 then determines the antenna branch of the minimum branch SIR being active. Assume, e. g., that the antenna branch 30 is determined as the one being active of the minimum branch SIR.

Going back to FIG. 2, the control circuit 60 switches off the antenna branch 30 (step “S4”), i.e., turns off supplying power at least to the radio circuit 31 and the path selector circuit 32.

The receiving apparatus 1 continues operating the two antenna branches 10 and 20 being active. The evaluation circuit 50 evaluates the BER of a selective-combined and decoded signal out of those two antenna branches 10 and 20 by the criterion and informs the control circuit 60 of a result of that evaluation.

In a case where the BER is no higher than the criterion (“YES” of step “S5”), the control circuit 60 compares the SIRs of the two antenna branches 10 and 20 (step “S6”) like step “33”. The control circuit determines one of them as the antenna branch of the minimum branch SIR being active. Assume here that the antenna branch 20 is determined as the one being active of the minimum branch SIR.

Following the step “S6”, the control circuit 60 switches off the antenna branch 20 (step “S7”), i.e., turns off supplying power at least to the radio circuit 21 and the path selector circuit 22.

The control circuit 60 continues operating the antenna branch 10, and the evaluation circuit 50 continues evaluating the BER of the selective-combined and decoded signals as long as the criterion is met (“YES” of step “S8”).

If the BER is higher than the criterion on the step “S2” (“NO” of step “S2”), the control circuit 60 continues the three-antenna branch operation, and the evaluation circuit 50 continues evaluating the BER of the selective-combined and decoded signals.

If the BER is higher than the criterion on the step “S5” (“NO” of step “S5”), the control circuit 60 switches on the antenna branch 30 being inactive to go back to the three-antenna branch operation (step “S9”). If the BER is higher than the criterion on the step “S8” (“NO” of step “S8”), the control circuit 60 switches on the antenna branches 20 and 30 being inactive to go back to the three-antenna branch operation (step “S9”).

The number of the antenna branches is not limited to three in the first embodiment. According to the first embodiment described above, the receiving apparatus 1 may be operated with a reduced number of active antenna branches to save power consumption as long as its receiving quality in terms of the BER is kept satisfactory.

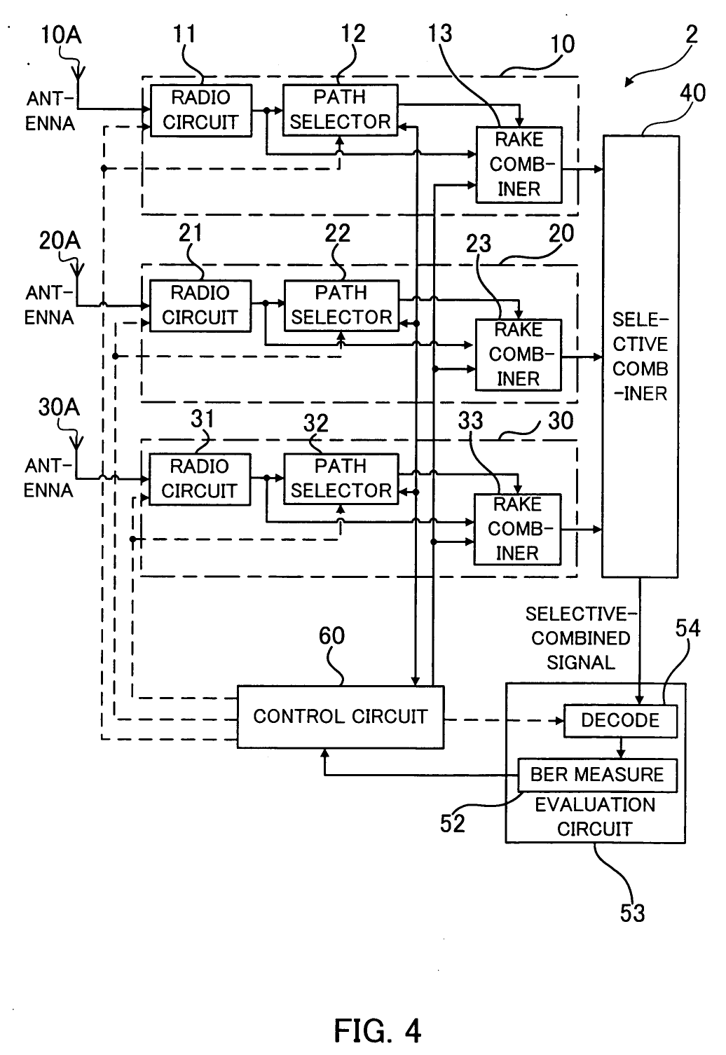

A second embodiment of the present invention will be described with reference to FIG. 4, a block diagram of a main part of a receiving apparatus 2 in the second embodiment. The receiving apparatus 2 has three antenna branches 10, 20 and 30, a selective combiner circuit 40, an evaluation circuit 53 and a control circuit 60. Every component except for the evaluation circuit 53 is the same as the one in FIG. 1 given the same reference numeral and its explanation is omitted.

The evaluation circuit 53 has a decoding circuit 54 and a BER measuring circuit 52, the latter is the same as the one in FIG. 1. The decoding circuit 54 performs soft-decision decoding on the selective-combined signal that is applied thereto from the selective-combiner circuit 40. The decoding circuit 54 is given information on the number of the antenna branches being active from the control circuit 60 and uses a symbol metric inversely proportional to that number for soft-decision decoding.

A degree of reliability of the selective-combined signal expressed as the number of the antenna branches being active is reflected on the symbol metric so that soft-decision decoding is properly performed by the decoding circuit 54.

According to the second embodiment described above, soft-decision decoding may also be performed while the number of the antenna branches being active is reduced.

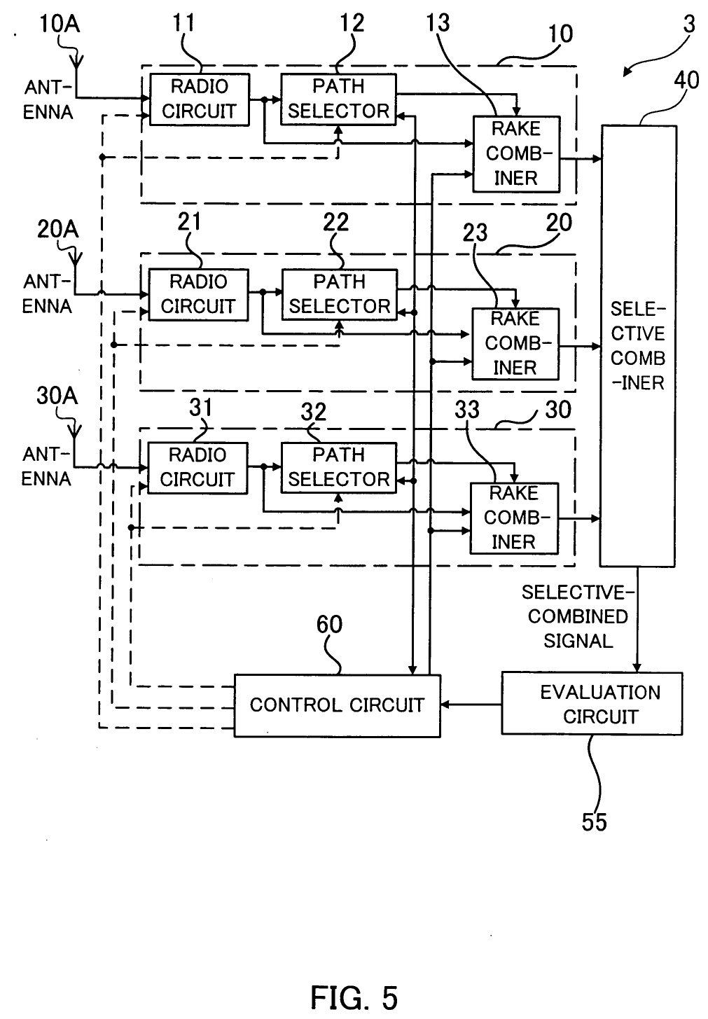

A third embodiment of the present invention will be described with reference to FIG. 5 through FIG. 7. FIG. 5 is a block diagram of a main part of a receiving apparatus 3 in the third embodiment. The receiving apparatus 3 has three antenna branches 10, 20 and 30, a selective combiner 40, an evaluation circuit 55 and a control circuit 60. Every component except for the evaluation circuit 55 is the same as the one in FIG. 1 given the same reference numeral and its explanation is omitted.

The selective-combined signal is applied to and evaluated by the evaluation circuit 55, which will be described with reference to FIG. 6. The selective-combined signal is a series of received symbols and each received symbol may be plotted on a constellation diagram.

FIG. 6 is an example of such a constellation diagram in a case where the primary modulation of the spread spectrum signal is quadrature phase shift keying (QPSK). In FIG. 6, samples of received symbols are plotted around a true symbol in each quadrant. Each symbol deviates from the true symbol due to interference or noise, and variance of every deviation (a distance between each received symbol and the true symbol in each quadrant) is a figure of merit of the selective-combined signal.

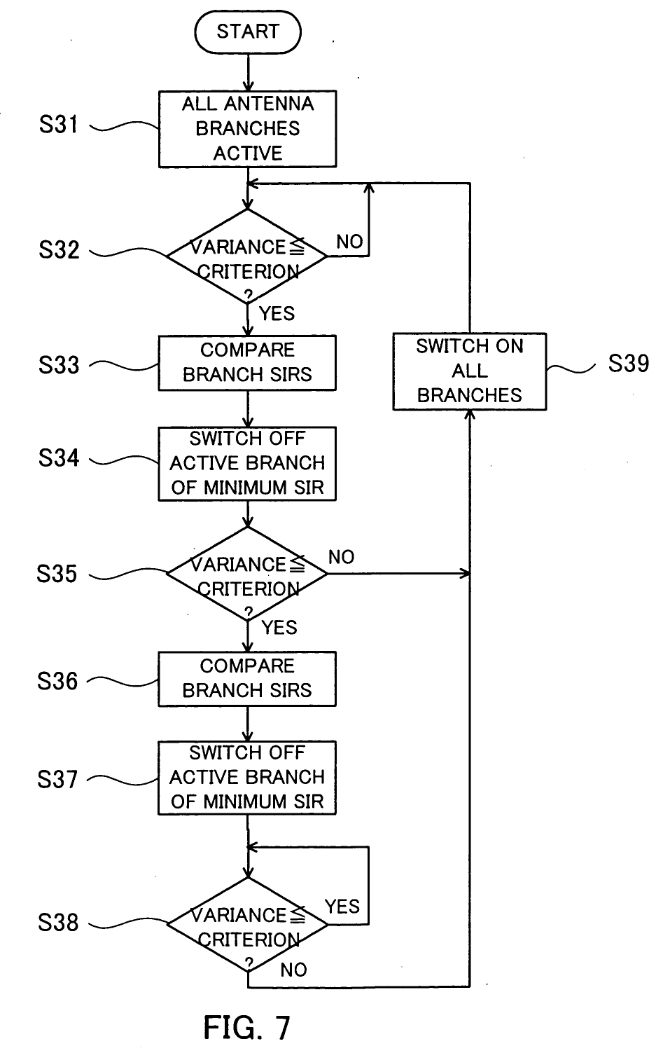

The evaluation circuit 55 thereby evaluates calculated variance of those deviations by a criterion. A value of the variance which is no higher than the criterion meets the criterion. The control circuit 60 obtains a result of the evaluation from the evaluation circuit 55 and manages to switch each antenna branch 10, 20 or 30 between active and inactive based on the result, as illustrated in a flow chart of FIG. 7.

FIG. 7 is the same as FIG. 2 except that the criterion of the selective-combined signal is not the BER thereof after being decoded but the variance of the deviation of each received symbol. Thus the whole procedure of the steps “S31” through “S39” in FIG. 7 is the same as the steps in FIG. 2 except for the steps “S32”, “S35” and “S38” where the variance, not the BER, is compared with a criterion.

According to the third embodiment described above, an effect of saving power consumption is obtained as in the first embodiment while receiving quality evaluated in a different way is kept satisfactory.

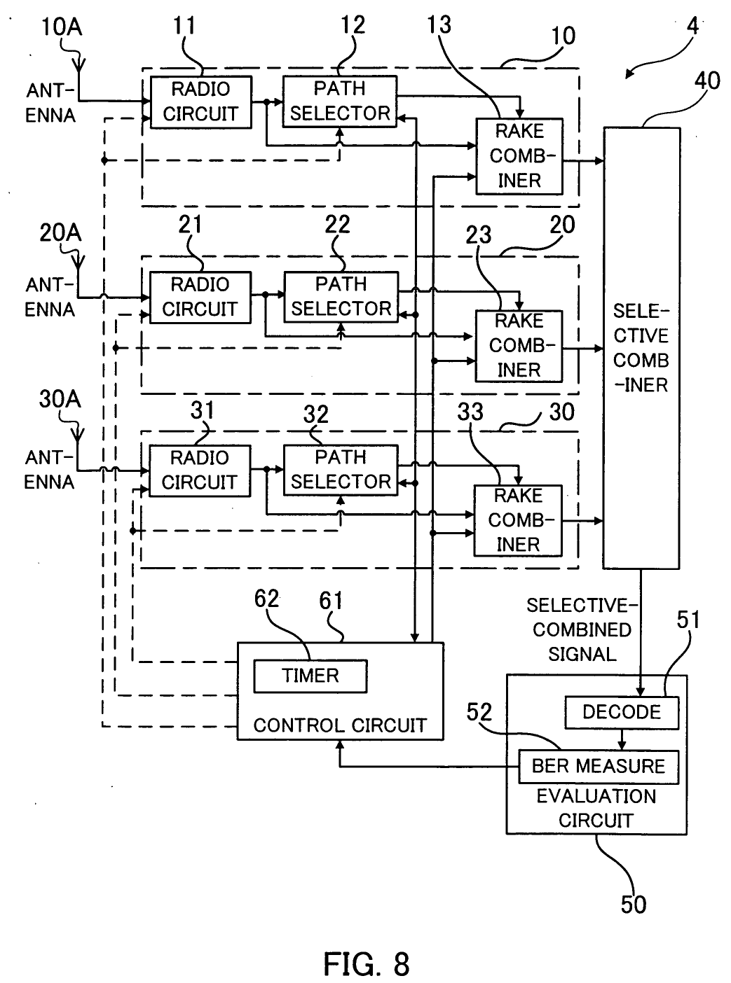

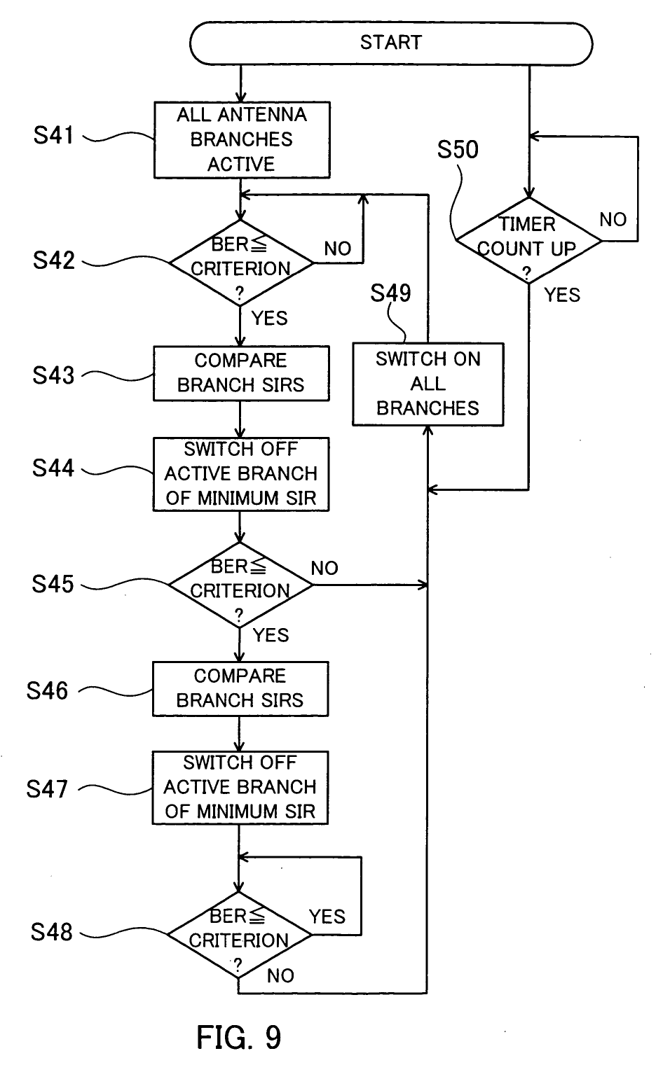

A fourth embodiment of the present invention will be described with reference to FIG. 8 and FIG. 9. FIG. 8 is a block diagram of a main part of a receiving apparatus 4 in the fourth embodiment. The receiving apparatus 4 has three antenna branches 10, 20 and 30, a selective combiner 40, an evaluation circuit 50 and a control circuit 61. Every component except for the control circuit 61 is the same as the one in FIG. 1 given the same reference numeral and its explanation is omitted.

The control circuit 61 includes a timer 62 that generates a periodic signal and switches on any inactive one of the antenna branches 10, 20 and 30 triggered by that periodic signal, as illustrated in a flow chart of FIG. 9.

In FIG. 9, the steps “S41 ” through “S49” is the same as the steps “S1” through “S9” in FIG. 2 and their explanations are omitted. In parallel with those steps “S41” through “S49”, the control circuit 61 watches the timer 62 (step “S50”) and waiting until it counts up to a given period to generate a periodic signal (“NO” of step “S50”). When the periodic signal is generated (“YES” of step “S50”), the control circuit 61 switches on any inactive one of the antenna branches 10, 20 and 30 to go back to three-antenna branch operation (step “S49”).

The number of the antenna branches is not limited to three in the fourth embodiment. The above procedure of switching on any inactive antenna branch periodically is added to the procedure of the first embodiment. It may be added to the procedure of the second or the third embodiment as well.

According to the fourth embodiment described above, an event of degrading the receiving quality down to a level lower than the required one becomes less probable as all the antenna branches are switched on periodically.

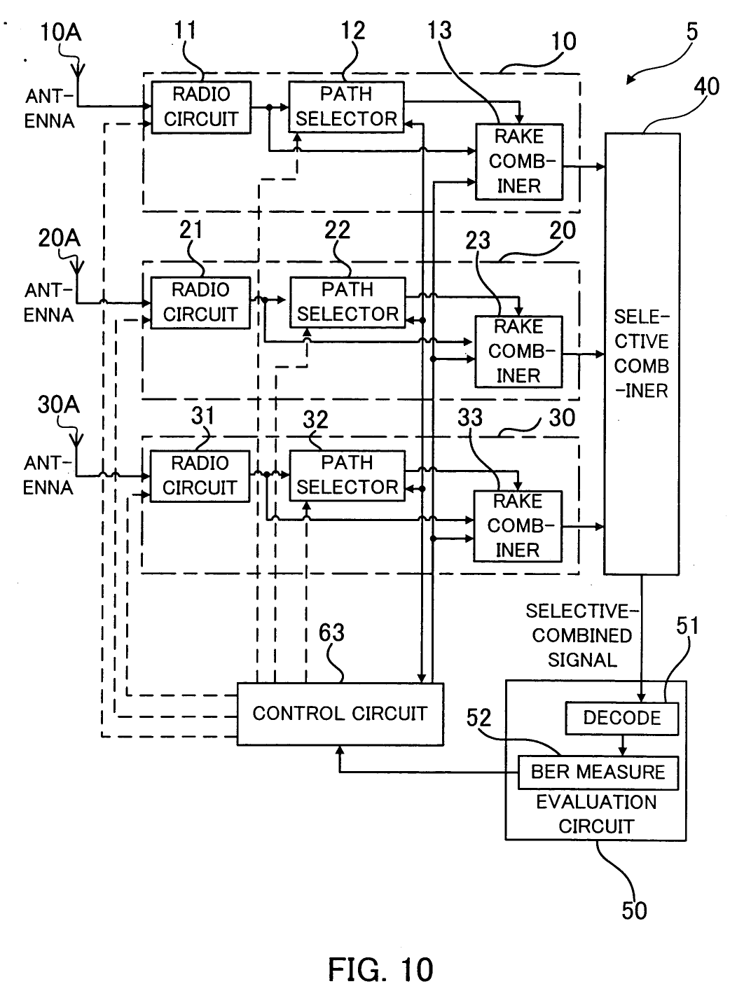

A fifth embodiment of the present invention will be described with reference to FIG. 10 through FIG. 12. FIG. 10 is a block diagram of a main part of a receiving apparatus 5 in the fifth embodiment. FIG. 10 is the same as FIG. 1 except that the radio circuit 11 and the path selector circuit 12, of the antenna branch 10 e.g., are distinctly connected to a control circuit 63 with separate dashed lines. That is, the control circuit 63 may manage to switch on or off the radio circuit 11 and the path selector circuit 12 separately for the antenna branch 10, which is the same for the other antenna branches 20 and 30. Each component other than the control circuit 63 is the same as the one given the same reference numeral in FIG, 1 and its explanation is omitted.

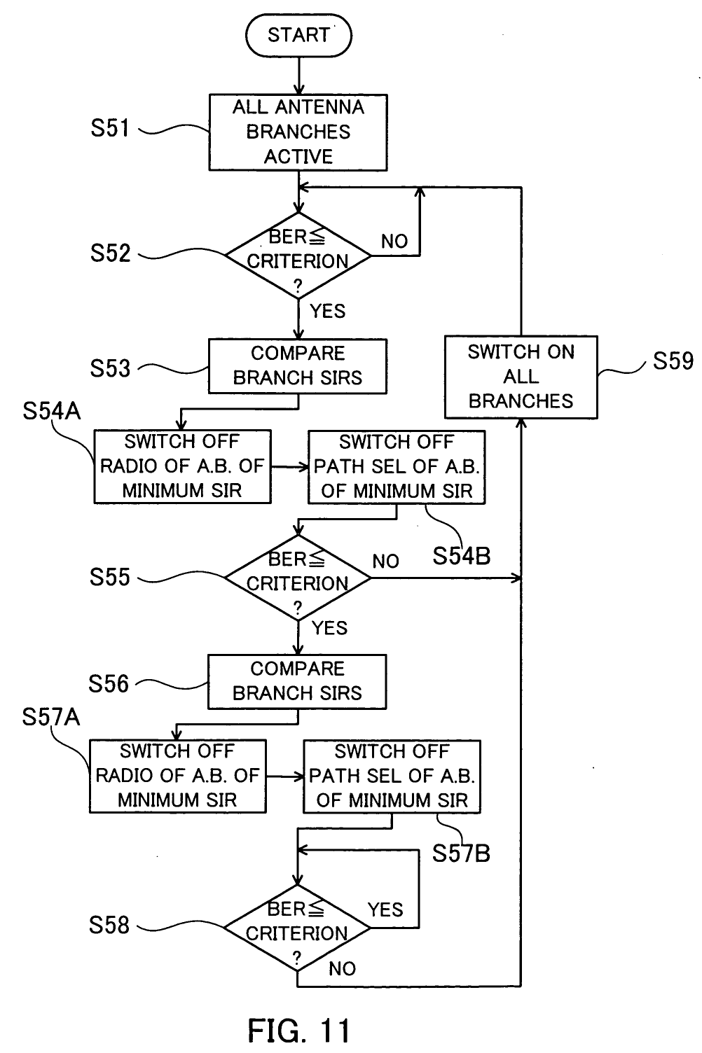

A procedure of switching each antenna branch 10, 20 or 30 between active and inactive is illustrated in a flow chart of FIG. 11. In FIG. 11, the first three steps “S51”, “S52” and “S53” are the same as the steps “S1 ”, “S2” and “S3” in FIG. 2, respectively.

When the control circuit 63 switches off the antenna branch 30 that happens to be of the minimum branch SIR, it turns off supplying power to the radio circuit 31 (step “S54A”) and after that turns off supplying power to the path selector circuit 32 (step “S54B”). The following steps “S55” and “S56” are the same as the steps “S5” and “S6” in FIG. 2, respectively.

When the control circuit 63 switches off the antenna branch 20 that happens to be of the minimum branch SIR, it turns off supplying power to the radio circuit 21 (step “S57A”) and after that turns off supplying power to the path selector circuit 22 (step “S57B”). The following steps “S58” and “S59” are the same as the steps “S8” and “S9” in FIG. 2, respectively.

Transient power dissipation of switching components between active and inactive may be decreased by turning off supplying power to the radio circuit 31 (or 21, 11) and to the path selector circuit 32 (or 22, 11) separately in time.

On the step “S59” the control circuit 63 may turn on supplying power to the radio circuit 31 (or 21, 11) and to the path selector circuit 32 (or 22, 11) separately in time, to obtain a similar effect of saving transient power dissipation.

On the steps “S52”, “S55” and “S58”, the BER may be measured after soft-decision decoding as in the second embodiment. On those steps the figure of merit compared to the criterion may be the variance of the deviation of each received symbol as in the third embodiment.

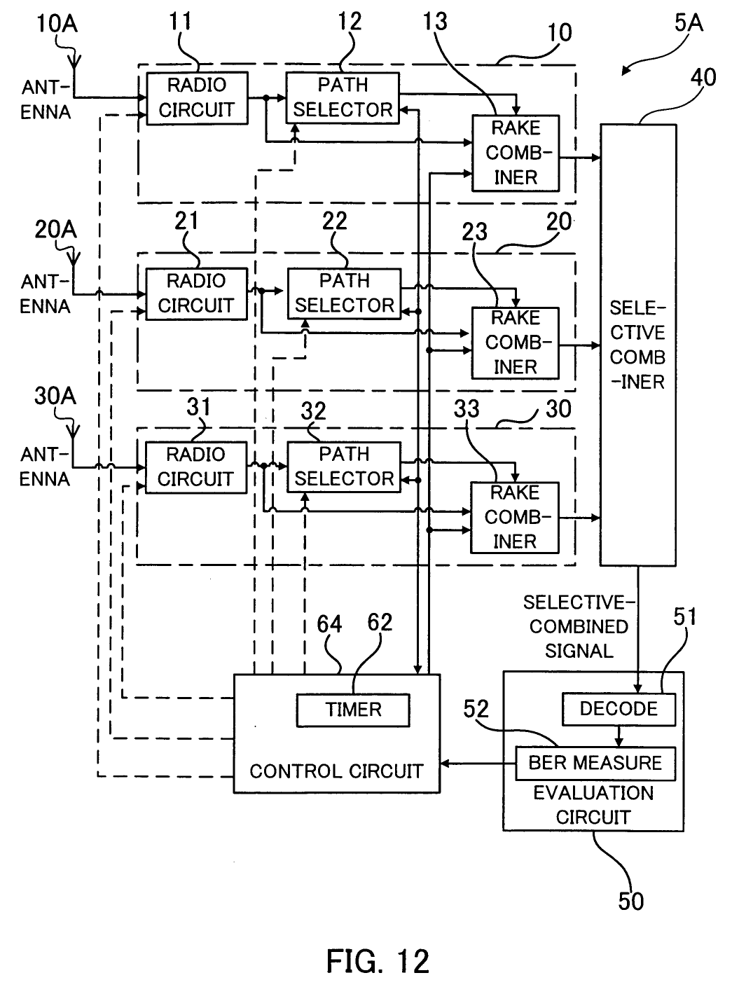

FIG. 12 is a block diagram of a main part of another receiving apparatus 5A in the fifth embodiment. The receiving apparatus 5A is a combination of the receiving apparatus 4 in the fourth embodiment and the receiving apparatus 5, and has a control circuit 64 that includes a timer 62, the same as the one in FIG. 8, and is distinctly connected to the radio circuit and the path selector circuit of each antenna branch 10, 20 or 30.

The control circuit 64 switches off the radio circuit 11 (or 21, 31) and the path selector circuit 12 (or 22, 32) separately in time, like the control circuit 63 of the receiving apparatus 5. It switches on any antenna branch being inactive periodically triggered by the timer 62 as in the fourth embodiment. Further the control circuit 64 may turn on supplying power to the radio circuit 31 (or 21, 11) and to the path selector circuit 32 (or 22, 11) periodically and separately in time.

According to the fifth embodiment described above, transient power consumption may be reduced due to switching on or off each component of each antenna branch separately in time.

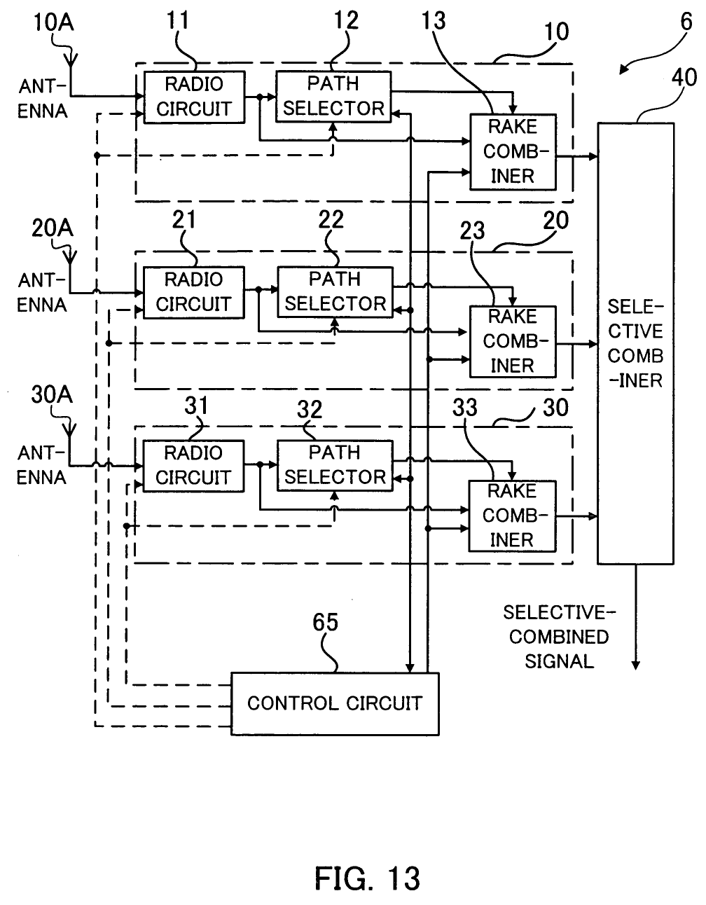

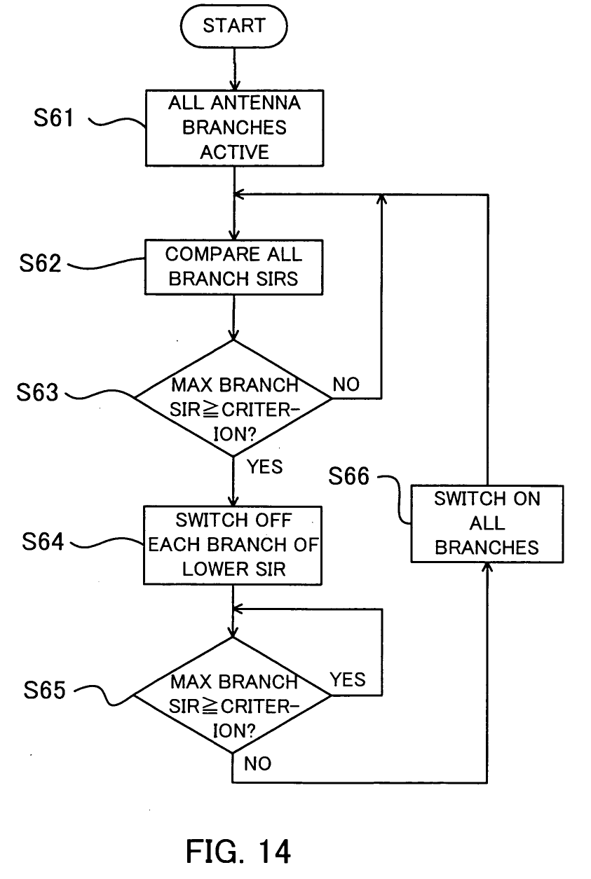

A sixth embodiment of the present invention will be described with reference to FIG. 13 and FIG. 14. FIG. 13 is a block diagram of a main part of a receiving apparatus 6 in the sixth embodiment. The receiving apparatus 6 has three antenna branches 10, 20 and 30, each being connectable to an antenna 10A, 20A or 30A, and a selective combiner circuit 40. They are the same as those given the same reference numerals in FIG. 1 and their explanations are omitted.

The receiving apparatus 6 has a control circuit 65 that manages to switch each antenna branch 10, 20 or 30 between active and inactive, i.e., to switch on or off each antenna branch like the control circuit 60 in the first embodiment.

A spread spectrum signal reaching the antennas 10A, 20A and 30A in a multipath environment is received and processed by the antenna branches 10, 20 and 30 and the selective combiner circuit 40 in the same manner as described in the first embodiment and its explanation is omitted.

The control circuit 65 manages to switch on or off each antenna branch 10, 20 or 30 as illustrated in a flow chart of FIG. 14. At first (“START”) all the antenna branches 10, 20 and 30 are being active (step “S61”). The control circuit 65 determines a branch SIR of each antenna branch 10, 20 or 30 and compares among those branch SIRs in the same manner as described in the first embodiment (step “S62”).

Assume, e.g., that the antenna branch 10 is determined as the one of the maximum branch SIR as a result of the above comparison. The control circuit 65 examines if the branch SIR of the antenna branch 10 meets a criterion thereof, and in a case where the criterion is met (“YES” of step “S63”), switches off the antenna branches 20 and 30 (step “S64”).

The control circuit 62 continues operating the antenna branch 10, and examining the branch SIR of the antenna branch 10 as long as it meets the criterion (“YES” of step “S65”).

If the branch SIR of the antenna branch 10 does not meet the criterion on the step “S63” (“NO” of step “S63”), the control circuit 65 continues three-antenna branch operation. If the branch SIR of the antenna branch 10 is degraded not to meet the criterion on the step “S65” (“NO” of step “S65”), the control circuit 65 switches on the antenna branches 20 and 30 being inactive to go back to three-antenna branch operation (step “S66”).

The number of the antenna branches is not limited to three in the sixth embodiment. The control circuit 65 may be modified to further switch on any antenna branch 10, 20 or 30 being inactive periodically in time as described in the fourth embodiment, or to manage to switch on or off the radio circuit and the path selector circuit of each antenna branch 10, 20 or 30 separately in time as described in the fifth embodiment.

According to the sixth embodiment described above, only one antenna branch is switched on when its branch SIR is the maximum and meets the criterion, in order to save power consumption.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A receiving apparatus receiving and processing spread spectrum radio signals comprising:
a plurality of antenna branches each configured to be switched between active and inactive and each having a radio circuit connectable to an antenna, a path selector circuit and a rake combiner circuit including a plurality of rake fingers, the radio circuit receiving a spread spectrum signal via the antenna after the spread spectrum signal follows a plurality of paths in a case where multipath occurs, the path selector circuit including a matched filter to detect each path by detecting a phase of synchronization and an SIR thereof out of the received spread spectrum signal, selecting the detected paths as many as the rake fingers at most in decreasing order of the SIRs thereof and assigning each selected path to each rake finger, the rake combiner circuit despreading and demodulating the received spread spectrum signal on each rake finger and raking up the demodulated signal of every rake finger according to each assigned path;
a selective combiner circuit combining the raked-up signal of each antenna branch as selective combining;
an evaluation circuit evaluating a figure of merit of the selective-combined signal by a criterion; and
a control circuit determining a branch SIR as one of the maximum value and the mean value of the SIR of each selected path for each antenna branch, and switching off one of the antenna branches being active and of the minimum branch SIR in a case where at least two of the antenna branches are being active and the criterion is met.

2. The receiving apparatus of claim 1, wherein the evaluation circuit decoding the selective-combined signal and the figure of merit is a BER of the selective-combined and decoded signal.

3. The receiving apparatus of claim 1, wherein the evaluation circuit performing soft-decision decoding, with a symbol metric being inversely proportional to the number of the antenna branches being active, on the selective-combined signal and the figure of merit is a BER of the selective-combined and decoded signal.

4. The receiving apparatus of claim 1, wherein the figure of merit is variance of a plurality of deviations in a constellation of the selective-combined signal formed by a series of received symbols, each deviation being a distance between each received symbol and a true symbol thereof in the constellation.

5. The receiving apparatus of claim 1, wherein the control circuit further switching on each antenna branch being inactive in a case where the criterion is not met.

6. The receiving apparatus of claim 1, wherein the control circuit further switching on each antenna branch being inactive periodically in time.

7. The receiving apparatus of claim 1, wherein the control circuit switching off the receiving circuit of the antenna branch of the minimum branch SIR and the path selector circuit thereof separately in time.

8. The receiving apparatus of claim 1, wherein the control circuit switching off the receiving circuit of the antenna branch of the minimum branch SIR and the path selector circuit thereof separately in time, and further switching on the receiving circuit of each antenna branch being inactive and the path selector circuit thereof separately in time in a case where the criterion is not met.

9. The receiving apparatus of claim 1, wherein the control circuit switching off the receiving circuit of the antenna branch of the minimum branch SIR and the path selector circuit thereof separately in time, and further switching on the receiving circuit of each antenna branch being inactive and the path selector circuit thereof separately and periodically in time.

10. A receiving apparatus receiving and processing spread spectrum radio signals comprising:
a plurality of antenna branches each configured to be switched between active and inactive and each having a radio circuit connectable to an antenna, a path selector circuit and a rake combiner circuit including a plurality of rake fingers, the radio circuit receiving a spread spectrum signal via the antenna after the spread spectrum signal follows a plurality of paths in a case where multipath occurs, the path selector circuit including a matched filter to detect each path by detecting a phase of synchronization and an SIR thereof out of the received spread spectrum signal, selecting the detected paths as many as the rake fingers at most in decreasing order of the SIRs thereof and assigning each selected path to each rake finger, the rake combiner circuit despreading and demodulating the received spread spectrum signal on each rake finger and raking up the demodulated signal of every rake finger according to each assigned path;
a selective combiner circuit combining the raked-up signal of each antenna branch as selective combining; and
a control circuit determining a branch SIR as one of the maximum value and the mean value of the SIR of each selected path for each antenna branch, selecting one of the antenna branches of the maximum branch SIR and switching off each unselected antenna branch in a case where the branch SIR of the selected antenna branch meets a criterion thereof.

11. The receiving apparatus of claim 10, wherein the control circuit further switching on each antenna branch being inactive in a case where the branch SIR of the selected antenna branch is degraded not to meet the criterion after each unselected antenna branch is switched off.

12. The receiving apparatus of claim 10, wherein the control circuit further switching on each antenna branch being inactive periodically in time.

13. The receiving apparatus of claim 10, wherein the control circuit switching off the receiving circuit of each unselected antenna branch and the path selector circuit thereof separately in time.

14. The receiving apparatus of claim 10, wherein the control circuit switching off the receiving circuit of each unselected antenna branch and the path selector circuit thereof separately in time, and further-switching on the receiving circuit of each antenna branch being inactive and the path selector circuit thereof separately in time in a case where the SIR of the selected antenna branch is degraded not to meet the criterion after each unselected antenna branch is switched off.

15. The receiving apparatus of claim 10, wherein the control circuit switching off the receiving circuit of each unselected antenna branch and the path selector circuit thereof separately in time, and further switching on the receiving circuit of each antenna branch being inactive and the path selector circuit thereof separately and periodically in time.

16. A method for receiving and processing spread spectrum radio signals with a receiving apparatus having a plurality of antenna branches each being connectable to an antenna, including a plurality of rake fingers and configured to be switched between active and inactive, comprising:
receiving a spread spectrum signal via each antenna on each antenna branch after the spread spectrum signal follows a plurality of paths in a case where multipath occurs;
detecting each path by detecting a phase of synchronization and an SIR thereof out of the received spread spectrum signal on each antenna branch with a matched filter included therein;
selecting the detected paths as many as the rake fingers at most in decreasing order of the SIRs thereof and assigning each selected path to each rake finger on each antenna branch;
despreading and demodulating the received spread spectrum signal on each rake finger on each antenna branch;
raking up the demodulated signal of every rake finger according to each assigned path on each antenna branch;
combining the raked-up signal of each antenna branch as selective combining;
evaluating a figure of merit of the selective-combined signal by a criterion;
determining a branch SIR as one of the maximum value and the mean value of the SIR of each selected path for each antenna branch; and
switching off one of the antenna branches being active and of the minimum branch SIR in a case where at least two of the antenna branches are being active and the criterion is met.

17. The method for receiving and processing spread spectrum radio signals of claim 16 further comprising switching on each antenna branch being inactive in a case where the criterion is not met.

18. The method for receiving and processing radio signals of claim 16 further comprising switching on each antenna branch being inactive periodically in time.
